(19) United States
(12) Patent Application Publication
(10) Pub. No.: US 2026/0313061 A1
(43) Pub. Date: Oct. 8, 2026

(54) IMAGER AND NON-TRANSITORY RECORDING MEDIUM

(71) Applicant: PFU LIMITED, Kahoku-shi (JP)

(72) Inventor: Tomoaki Wada, ISHIKAWA (JP)

(21) Appl. No.: 19/632,912

(22) Filed: Mar. 30, 2026

(30) Foreign Application Priority Data
Apr. 8, 2025 (JP) 2025-063723

(51) Int. Cl. H04N 1/387; H04N 1/031; H04N 1/203

(52) U.S. Cl. CPC H04N 1/3876; H04N 1/031; H04N 1/2032; H04N 1/3872

(57) ABSTRACT

An imager includes an imaging device including an imaging sensor, and circuitry. The circuitry receives, from an external information processing apparatus, an operation signal for a process corresponding to one of a type and a state of a medium having an overlapping portion; and control the imaging device according to the received operation signal, to image the medium and generate an input image. The circuitry transmits the input image to the information processing apparatus, and the information processing apparatus performs a double-page spread combination process or a rearrangement process on the received input image according to the one of the type and the state of the medium.

### CROSS-REFERENCE TO RELATED APPLICATIONS

This patent application is based on and claims priority pursuant to 35 U.S.C. §119(a) to Japanese Patent Application No. 2025-063723, filed on Apr. 8, 2025, in the Japan Patent Office, the entire disclosure of which is hereby incorporated by reference herein.

### BACKGROUND

The present disclosure relates to an imager and a non-transitory recording medium.

There is a reading apparatus that identifies a document region, which corresponds to the portion of the image representing the surface of the document to be read, from image data obtained by reading a document folded in half (a document in a two folded state), and extracts the image within the document region.

### SUMMARY

The imager according to one aspect of the present disclosure includes an imaging device including an imaging sensor, and circuitry. The circuitry receives, from an external information processing apparatus, an operation signal for a process corresponding to one of a type and a state of a medium having an overlapping portion; and control the imaging device according to the received operation signal, to image the medium and generate an input image. The circuitry transmits the input image to the information processing apparatus, and the information processing apparatus performs a double-page spread combination process or a rearrangement process on the received input image according to the one of the type and the state of the medium.

The imager according to one aspect of the present disclosure includes a conveyor to convey a medium, an imaging device including an imaging sensor, to image the medium conveyed by the conveyor and generate an input image, and a circuitry. The circuitry receives a specification indicating one of a type and a state of a medium having an overlapping portion. The circuitry performs at least one of controlling the imaging device according to the one of the type and the state to process the input image, performing image processing on the input image, or controlling an external device to perform image processing on the input image, wherein the external device is external to the imager.

The computer-readable, non-transitory medium according to one aspect of the present disclosure stores a plurality of instructions that, when executed by one or more processors of an information processing apparatus, cause the one or more processors to execute a process. The process includes receiving a specification indicating one of a type and a state of a medium having an overlapping portion, receiving an input image generated by an imager that images a medium, and performing a double-page spread combination process or a rearrangement process on the received input image according to the one of the type and the state of the medium.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an image processing system;

FIG. 2 is a diagram illustrating a conveying path in a scanner;

FIG. 3 is a block diagram illustrating schematic configurations of the scanner and an information processing apparatus;

FIG. 4 is a diagram illustrating schematic configurations of a first memory and a first processing circuit;

FIG. 5 is a table presenting an example of a data structure of a setting table;

FIGS. 6A and 6B are schematic diagrams illustrating an example of a double-page spread medium;

FIGS. 6C and 6D are schematic diagrams illustrating an example of a booklet-shaped medium;

FIG. 7 is a flowchart presenting an example of an operation of a medium reading process;

FIG. 8 is a schematic diagram illustrating an example of display data;

FIG. 9 is a schematic diagram illustrating an example of display data;

FIG. 10 is a flowchart presenting an example of an operation of an update process;

FIG. 11 is a schematic diagram illustrating an example of another display data;

FIG. 12 is a table presenting an example of a data structure of another setting table;

FIG. 13 is a schematic diagram illustrating an example of another display data;

FIG. 14 is a diagram illustrating schematic configurations of another second memory and another second processing circuit;

FIG. 15A is a flowchart presenting an example of an operation of a setting process;

FIG. 15B is a flowchart presenting an example of an operation of a reception process;

FIG. 16 is a diagram illustrating a schematic configuration of another first processing circuit; and

FIG. 17 is a diagram illustrating a schematic configuration of another second processing circuit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms "a," "an," and "the" are intended to include the plural forms as well, unless the context clearly indicates otherwise.

A scanner, an information processing method, and a program will be described below with reference to the drawings. The technical scope of the present disclosure is not limited to the embodiments described below and covers the contents described in the claims and the equivalents thereof.

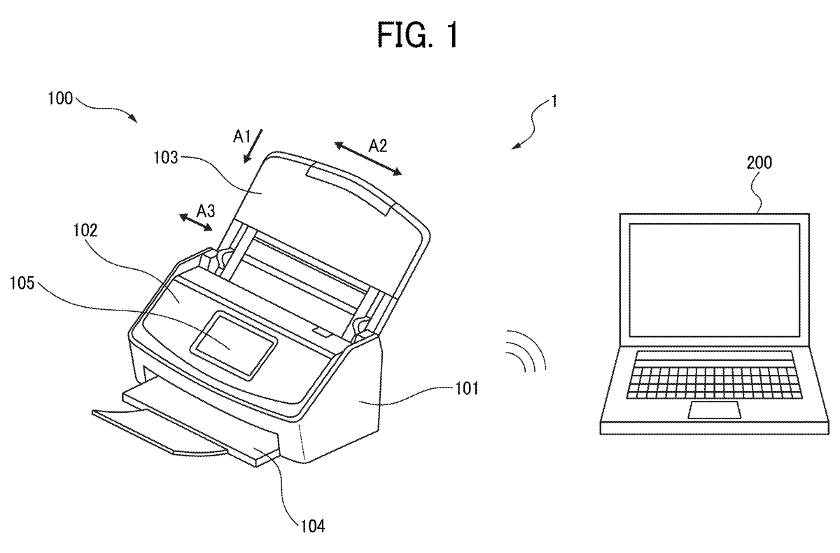

FIG. 1 is a diagram illustrating a configuration of an image processing system 1.

The image processing system 1 includes a scanner 100 and an information processing apparatus 200. The scanner 100 and the information processing apparatus 200 are connected to each other for communication. The scanner 100 is an example of an imager that conveys a medium serving as a document and images the medium. Examples of the medium include paper, thick paper, a card, a booklet, and a passport. The scanner 100 may be a facsimile, a copier, or a multifunction peripheral (MFP). The information processing apparatus 200 is, for example, a personal computer. The information processing apparatus 200 may be a mobile phone, a smartphone, a tablet computer, or a notebook personal computer. The information processing apparatus 200 may be a server. In this case, multiple scanners 100 may be connected to one information processing apparatus 200 for communication.

In FIG. 1, arrow A1 indicates the direction in which a medium is conveyed (also "medium conveying direction A1"), arrow A2 indicates the width direction perpendicular to the medium conveying direction A1, and arrow A3 indicates the height direction perpendicular to a medium conveying path. In the following description, upstream is upstream in the medium conveying direction A1, and downstream is downstream in the medium conveying direction A1. The width direction A2 is an example of a direction intersecting the medium conveying direction A1.

The scanner 100 includes a lower housing 101, an upper housing 102, a media tray 103, an ejection tray 104, and a display and operation device 105.

The upper housing 102 is positioned to cover the upper surface of the scanner 100, and is hinged to the lower housing 101 and is openable and closable, for example, when a medium is jammed or when the inside of the scanner 100 is cleaned.

The media tray 103 is hinged to the lower housing 101 and is rotatable. When the scanner 100 is not used, the media tray 103 is positioned to cover the lower housing 101 and the upper housing 102 and functions as an exterior cover. In contrast, when the scanner 100 is used, the media tray 103 is positioned at such a position that media to be fed and conveyed can be placed thereon. The ejection tray 104 is engaged with the lower housing 101, and the ejected media are stacked thereon. The ejection tray 104 may be engaged with the upper housing 102 with, for example, a hinge.

The display and operation device 105 includes a display and an interface circuit that outputs image data to the display, and displays the image data on the display. Examples of the display include a liquid crystal display and an organic electro-luminescence (EL) display. The display and operation device 105 further includes a touch-screen input device and an interface circuit that receives signals from the input device. The display and operation device 105 receives an input operation performed by a user and outputs an operation signal corresponding to the input operation performed by the user. Alternatively, a display device and an operation device may be separate.

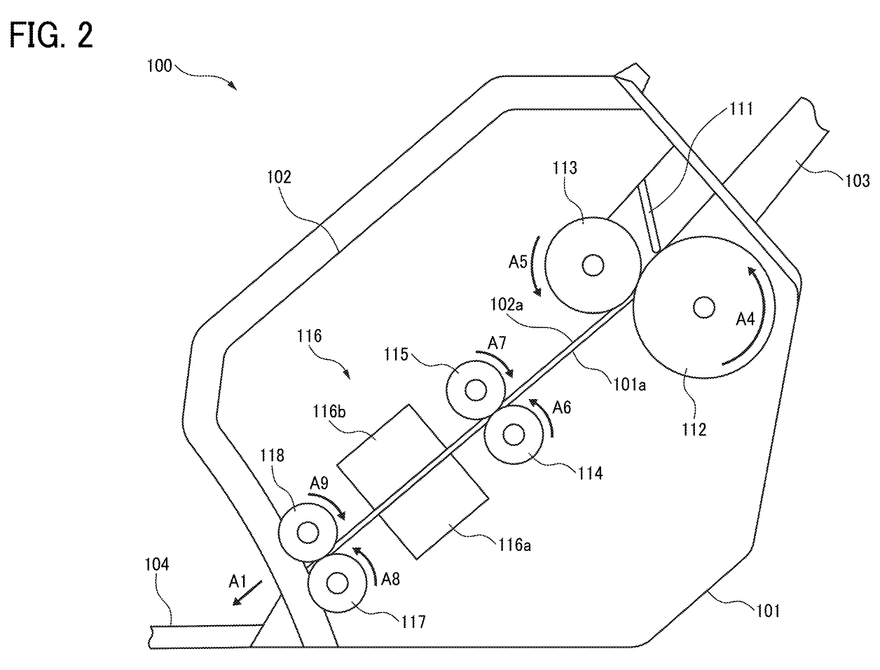

FIG. 2 is a diagram illustrating a conveying path in the scanner 100.

The scanner 100 includes a media sensor 111, a feed roller 112, a separation roller 113, a first conveyance roller 114, a second conveyance roller 115, an imaging device 116 including an imaging sensor, a first ejection roller 117, and a second ejection roller 118 along the conveying path.

The feed roller 112, the separation roller 113, the first conveyance roller 114, the second conveyance roller 115, the first ejection roller 117, and/or the second ejection roller 118 are examples of a conveyor that conveys a medium. The number of each of the feed roller 112, the separation roller 113, the first conveyance roller 114, the second conveyance roller 115, the first ejection roller 117, and/or the second ejection roller 118 is not limited to one and may be two or more. When the feed roller 112, the separation roller 113, the first conveyance roller 114, the second conveyance roller 115, the first ejection roller 117, and/or the second ejection roller 118 are formed of multiple rollers, the multiple rollers are located at intervals in the width direction A2.

The upper surface of the lower housing 101 forms a lower guide 101a for the medium conveying path, and the lower surface of the upper housing 102 forms an upper guide 102a for the medium conveying path. As illustrated in FIG. 2, the medium conveying path has a so-called straight path mechanism, and the vertical relative positions of the front side and the back side of a medium do not change between when the medium is fed from the media tray 103 and when the medium is ejected onto the ejection tray 104.

The media sensor 111 is located upstream from the feed roller 112 and the separation roller 113. The media sensor 111 includes a contact sensor and detects whether a medium is placed on the media tray 103. The media sensor 111 generates a media signal having a value that changes depending on whether a medium is placed on the media tray 103 and outputs the generated media signal. The media sensor 111 is not limited to a contact sensor. The media sensor 111 may be any desired sensor, such as an optical sensor, that detects the presence of a medium.

The feed roller 112 is in the lower housing 101, separates the media placed on the media tray 103 one by one from the bottom, and sequentially feeds the media. The separation roller 113 is a so-called brake roller or retard roller, located in the upper housing 102, and faces the feed roller 112. The separation roller 113 separates a medium from the media placed on the media tray 103. The separation roller 113 is rotatable in the direction indicated by arrow A5 opposite the rotation direction for feeding a medium (i.e., the medium feeding direction). Alternatively, the separation roller 113 is stoppable. Instead of the separation roller 113, a separation pad may be used.

The first conveyance roller 114 and the second conveyance roller 115 are located downstream from the feed roller 112 and the separation roller 113 in the medium conveying direction A1 and face each other. The first conveyance roller 114 and the second conveyance roller 115 convey the medium fed by the feed roller 112 and the separation roller 113 to the imaging device 116.

The imaging device 116 images the medium conveyed by the conveyor and generates an input image. The imaging device 116 includes a first imaging device 116a and a second imaging device 116b facing each other across the medium conveying path.

The first imaging device 116a includes an imaging sensor that is a unity-magnification contact image sensor (CIS) for each of red (R), green (G), and blue (B) colors. The CIS includes complementary metal oxide semiconductor (CMOS) imaging elements aligned linearly in the main scanning direction. The first imaging device 116a further includes a lens that forms an image on the imaging elements and an analog-to-digital (A/D) converter. The A/D converter amplifies the electrical signals output from the imaging elements and performs A/D conversion. The first imaging device 116a images the front side of the medium being conveyed, generates an input image, and outputs the input image.

Similarly, the second imaging device 116b includes an imaging sensor that is a unity-magnification CIS for each of RGB colors. The CIS includes CMOS imaging elements aligned linearly in the main scanning direction. The second imaging device 116b further includes a lens that forms an image on the imaging elements and an A/D converter. The A/D converter amplifies the electrical signals output from the imaging elements and performs A/D conversion. The second imaging device 116b images the back side of the medium being conveyed, generates an input image, and outputs the input image.

The scanner 100 may include only one of the first imaging device 116a and the second imaging device 116b and read one side of the medium. The imaging sensor may be a line sensor that employs a unity-magnification CIS including charge-coupled device (CCD) imaging elements. Alternatively, the imaging sensor may be a reduction-optical line sensor including CMOS or CCD imaging elements.

The first ejection roller 117 and the second ejection roller 118 are located downstream from the imaging device 116 in the medium conveying direction A1 and face each other. The first ejection roller 117 and the second ejection roller 118 eject the medium that is conveyed by the first conveyance roller 114 and the second conveyance roller 115 and is imaged by the imaging device 116 to the ejection tray 104.

The media placed on the media tray 103 are conveyed between the lower guide 101a and the upper guide 102a in the medium conveying direction A1 as the feed roller 112 rotates in the direction indicated by arrow A4 in FIG. 2, that is, in the medium feeding direction. The scanner 100 has two operation modes: a separation mode in which one medium is separated and fed from the media placed on the media tray 103, and a non-separation mode in which media are fed without being separated. In the separation mode, the separation roller 113 rotates in the direction indicated by arrow A5 opposite the medium feeding direction, or is kept stationary when a medium is conveyed. When multiple media are placed on the media tray 103, the medium in contact with the feed roller 112 is separated from the rest of the media placed on the media tray 103 due to the action of the feed roller 112 and the separation roller 113. This operation prevents a medium other than the separated medium from being conveyed (prevents multi-feed). In the non-separation mode, the separation roller 113 rotates following the feed roller 112 in the medium feeding direction opposite the direction indicated by arrow A5 when media are conveyed.

The medium is fed between the first conveyance roller 114 and the second conveyance roller 115 while being guided by the lower guide 101a and the upper guide 102a. The medium is fed between the first imaging device 116a and the second imaging device 116b as the first conveyance roller 114 and the second conveyance roller 115 rotate in the directions indicated by arrows A6 and A7, respectively. The medium read by the imaging device 116 is ejected onto the ejection tray 104 as the first ejection roller 117 and the second ejection roller 118 rotate in the directions indicated by arrows A8 and A9, respectively.

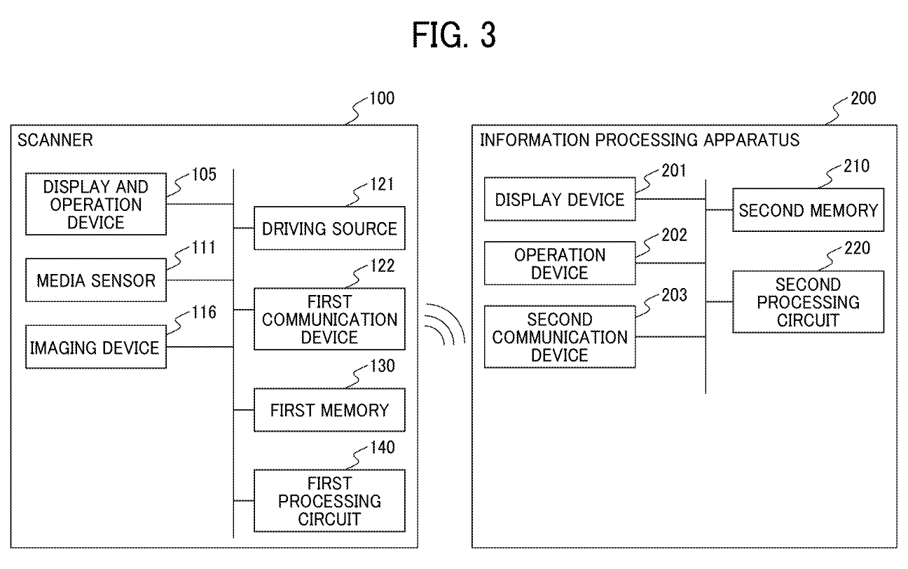

FIG. 3 is a block diagram illustrating schematic configurations of the scanner 100 and the information processing apparatus 200.

In addition to the above-described configuration, the scanner 100 further includes a driving source 121, a first communication device 122, a first memory 130, and a first processing circuit 140.

The driving source 121 includes one or more motors. The driving source 121 generates a driving force for rotating the feed roller 112, the separation roller 113, the first conveyance roller 114, the second conveyance roller 115, the first ejection roller 117, and/or the second ejection roller 118 according to a control signal from the first processing circuit 140. The driving source 121 is, for example, a direct current (DC) motor. The driving source 121 may be a motor other than a DC motor, such as a stepping motor. One of the first conveyance roller 114 and the second conveyance roller 115 may be a driven roller that rotates following the other roller. One of the first ejection roller 117 and the second ejection roller 118 may be a driven roller that rotates following the other roller.

The first communication device 122 includes an antenna that transmits and receives wireless signals, and a wireless communication interface circuit that transmits and receives signals through a wireless communication line in compliance with a given communication protocol. The given communication protocol is, for example, a wireless local area network (LAN) communication protocol. The first communication device 122 is connected to the information processing apparatus 200 via a network such as a wireless LAN or directly for communication to transmit and receive various images and information. The first communication device 122 may include a wired communication interface circuit to transmit and receive signals through a wired communication line in compliance with, for example, a wired LAN communication protocol. The first communication device 122 may include an interface circuit conforming to a serial bus such as a Universal Serial Bus (USB) or an interface circuit conforming to a short-range wireless communication standard such as Bluetooth^{®}, Near Field Communication (NFC), or TransferJet.

The first memory 130 includes memories such as a random-access memory (RAM) and a read-only memory (ROM); a fixed disk device such as a hard disk; or a portable memory such as a flexible disk or an optical disk. The first memory 130 stores, for example, computer programs, databases, and tables used for various processes performed by the scanner 100. The computer programs may be installed in the first memory 130 from a computer-readable portable recording medium using, for example, a setup program. The portable recording medium is, for example, a compact disc-read-only memory (CD-ROM) or a digital versatile disc-read-only memory (DVD-ROM). Further, the computer program may be externally distributed (e.g., from a server) and installed in the first memory 130. Further, data such as a setting table is stored in the first memory 130. Details of the setting table are deferred.

The first processing circuit 140 operates according to a program stored in the first memory 130 in advance. The first processing circuit 140 is, for example, a central processing unit (CPU). Alternatively, as the first processing circuit 140, for example, a digital signal processor (DSP), a large-scale integration (LSI) circuit, an application-specific integrated circuit (ASIC), or a field-programmable gate array (FPGA) may be used.

The first processing circuit 140 is connected to and controls the display and operation device 105, the media sensor 111, the imaging device 116, the driving source 121, the first communication device 122, and the first memory 130. The first processing circuit 140 controls operations such as the driving of the driving source 121 and the imaging by the imaging device 116 based on the media signal obtained from the media sensor 111. The first processing circuit 140 controls the driving source 121 or the imaging device 116 or processes an input image according to the type or state (form) of medium specified by the user, using the display and operation device 105 or the information processing apparatus 200.

The information processing apparatus 200 includes a display device 201, an operation device 202, a second communication device 203, a second memory 210, and a second processing circuit 220.

The display device 201 includes a display and an interface circuit that outputs image data to the display, and displays the image data on the display according to an instruction from the second processing circuit 220. Examples of the display device 201 include a liquid crystal display and an organic EL display.

The operation device 202 includes an input device and an interface circuit that receives signals from the input device. The operation device 202 receives an input operation performed by a user and outputs an operation signal corresponding to the input operation performed by the user to the second processing circuit 220. Examples of the input device include a keyboard and a mouse. Alternatively, a touch-screen input device may be used such that the display device and the operation device are integrally provided.

The second communication device 203 is an example of a communication unit, and includes an antenna that transmits and receives wireless signals, and a wireless communication interface circuit to transmit and receive signals through a wireless communication line in compliance with a given communication protocol such as a wireless LAN. The second communication device 203 can communicate with the scanner 100, and is connected to the scanner 100 for communication via a network such as a wireless LAN or directly to transmit and receive various images and information. The second communication device 203 may include a wired communication interface circuit to transmit and receive signals through a wired communication line in compliance with, for example, a wired LAN communication protocol. The second communication device 203 may include an interface circuit conforming to a serial bus such as a USB or an interface circuit conforming to a short-range wireless communication standard such as Bluetooth^{®}, NFC, or TransferJet.

The second memory 210 is an example of a storage unit and includes memories such as a RAM and a ROM; a fixed disk device such as a hard disk; or a portable memory such as an optical disk. The second memory 210 stores, for example, computer programs, databases, and tables, used in various processes performed by the information processing apparatus 200. The computer program may be installed in the second memory 210 from a computer-readable portable recording medium such as a CD-ROM or a DVD-ROM using, for example, a setup program. Further, the computer program may be externally distributed (e.g., from a server) and installed in the second memory 210.

The second processing circuit 220 operates according to a program stored in the second memory 210 in advance. The second processing circuit 220 is, for example, a CPU. For example, a DSP, an LSI circuit, an ASIC, or an FPGA may be used as the second processing circuit 220.

The second processing circuit 220 is connected to the display device 201, the operation device 202, the second communication device 203, and the second memory 210, and controls each of these components. The second processing circuit 220 receives an input image from the scanner 100 via the second communication device 203. The second processing circuit 220 processes an input image according to the type or state (form) of medium specified by the user using the operation device 202, or instructs the scanner 100 on the operation of the driving source 121, the operation of the imaging device 116, or the content of the image processing to be performed on the input image.

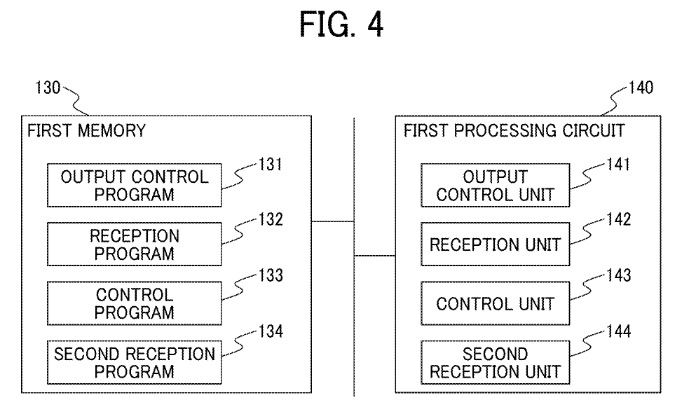

FIG. 4 is a diagram illustrating schematic configurations of the first memory 130 and the first processing circuit 140.

As illustrated in FIG. 4, the first memory 130 stores an output control program 131, a reception program 132, a control program 133, and a second reception program 134. These programs are functional modules implemented by software to operate on the processor. The first processing circuit 140 reads the programs from the first memory 130 and operates according to the read programs. Accordingly, the first processing circuit 140 functions as an output control unit 141, a reception unit 142, a control unit 143, and a second reception unit 144.

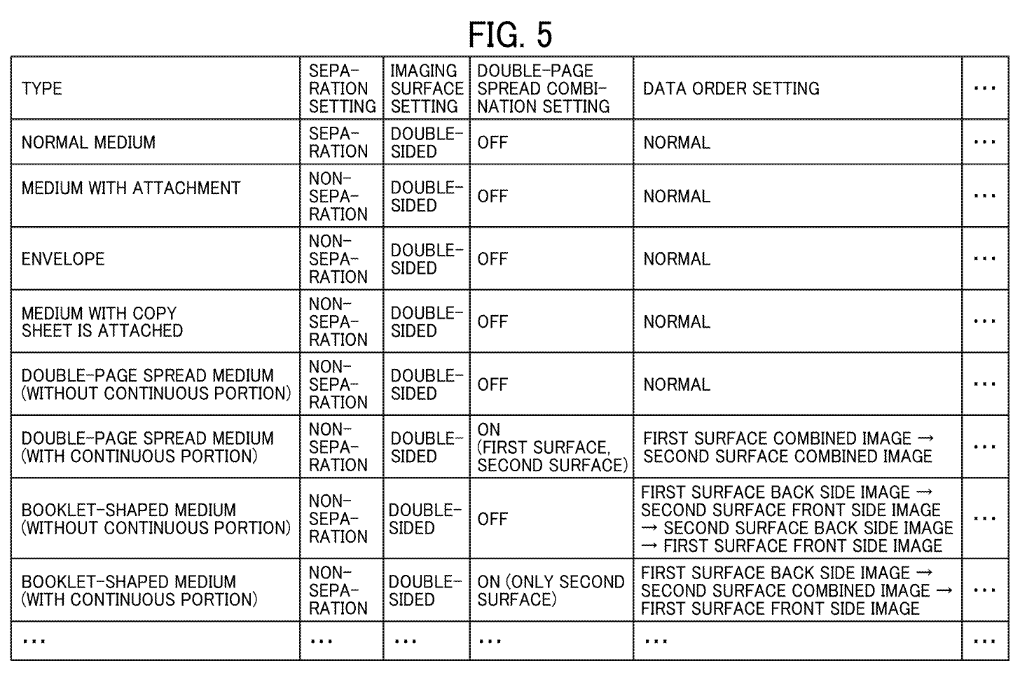

FIG. 5 is a diagram presenting a data structure of a setting table.

The media supported by the scanner 100 include a medium having an overlapping portion. The media include a medium to which an attachment such as a sticky note is attached, an envelope, a medium to which a copy sheet such as carbon paper or carbonless paper is attached, or a folded medium. The folded medium is, for example, a medium folded in half. The folded medium includes a double-page spread medium or a booklet-shaped medium. The double-page spread medium is a medium folded with a double-page spread on the outer side. With the double-page spread medium, a double-page spread may also be located on the inner side. Examples of the double-page spread medium include a medium including a portion (may be referred to as a "continuous portion" below) such as an image, characters (a sentence), or ruled lines continuous over multiple pages located with a fold line therebetween (across the fold line), and a medium not including a continuous portion." The booklet-shaped medium is a medium folded with a front cover and a back cover on the outer side. With the booklet-shaped medium, a double-page spread may also be located on the inner side. Examples of the booklet-shaped medium include a medium including a continuous portion and a medium not including a continuous portion.

As presented in FIG. 5, for each medium type, a setting corresponding to the type is stored in advance in the setting table. The types of medium include a normal medium not having an overlapping portion, a medium with an attachment, an envelope, a medium to which a copy sheet is attached, a double-page spread medium, or a booklet-shaped medium. By managing settings for each of these types, the scanner 100 or the information processing apparatus 200 can be appropriately controlled according to the type of medium conveyed. The double-page spread medium or the booklet-shaped medium includes a medium including a continuous portion or a medium not including a continuous portion. By managing the setting for each of the medium including a continuous portion and the medium not including a continuous portion, the scanner 100 or the information processing apparatus 200 can be appropriately controlled according to whether the medium includes a continuous portion.

The setting corresponding to each type includes a setting relating to a conveyance process performed by the conveyor, an imaging process performed by the imaging device 116, and/or image processing on an input image. The setting relating to the conveyance process is an example of a setting relating to the conveyor, and includes a separation setting. In the separation setting, one of a separation operation and a non-separation operation is specified when multiple sheets of media are placed on the media tray 103. In the separation operation, the media are separated and fed. In the non-separation operation, the media are fed without separated. The setting relating to the imaging process is an example of a setting relating to the imaging device, and includes an imaging surface setting. In the imaging surface setting, one of a double-sided imaging operation, in which both sides of a conveyed medium are imaged, and a single-sided imaging operation, in which only the front side of a conveyed medium is imaged, is specified. The setting relating to the image processing includes a double-page spread combination setting and a data order setting. In the double-page spread combination setting, whether to combine an input image representing the front side of a medium and an input image representing the back side of the medium is specified. In the data order setting, the order of arrangement of input images generated by the imaging device 116 is specified.

For the normal medium, the separation setting is set to the separation operation, the imaging surface setting is set to the double-sided imaging operation, the double-page spread combination setting is set to OFF, and the data order setting is set to a normal order. In the normal order, input images are arranged according to the conveyance order of the media, and, for each medium, the input image representing the front side of the medium precedes the input image representing the back side of the medium.

For the medium with an attachment, the separation setting is set to the non-separation operation, the imaging surface setting is set to the double-sided imaging operation, the double-page spread combination setting is set to OFF, and the data order setting is set to the normal order. When the separation setting is set to the non-separation operation for the medium with an attachment, undesirable separation of the attachment from the medium is prevented.

For the envelope, the separation setting is set to the non-separation operation, the imaging surface setting is set to the double-sided imaging operation, the double-page spread combination setting is set to OFF, and the data order setting is set to the normal order. When the separation setting is set to the non-separation operation for the envelope, damage to the envelope due to a separation force applied to the front side and the back side of the envelope is reduced.

For the medium to which a copy sheet is attached, the separation setting is set to the non-separation operation, the imaging surface setting is set to the single-sided imaging operation, the double-page spread combination setting is set to OFF, and the data order setting is set to the normal order. When the separation setting is set to the non-separation operation for the medium to which a copy sheet is attached, detachment of the copy sheet from the medium is reduced. In many cases, printing is not performed on the back side of the medium to which a copy sheet is attached, and when the imaging surface setting is set to the single-sided imaging operation for the medium to which a copy sheet is attached, the power consumption of the scanner 100 is reduced. For the medium to which a copy sheet is attached, the imaging surface setting may be set to the double-sided imaging operation.

For the double-page spread medium not including a continuous portion, the separation setting is set to the non-separation operation, the imaging surface setting is set to the double-sided imaging operation, the double-page spread combination setting is set to OFF, and the data order setting is set to the normal order. When the separation setting is set to the non-separation operation for the double-page spread medium not including a continuous portion, damage to the folded medium due to a separation force applied to the folded medium is reduced.

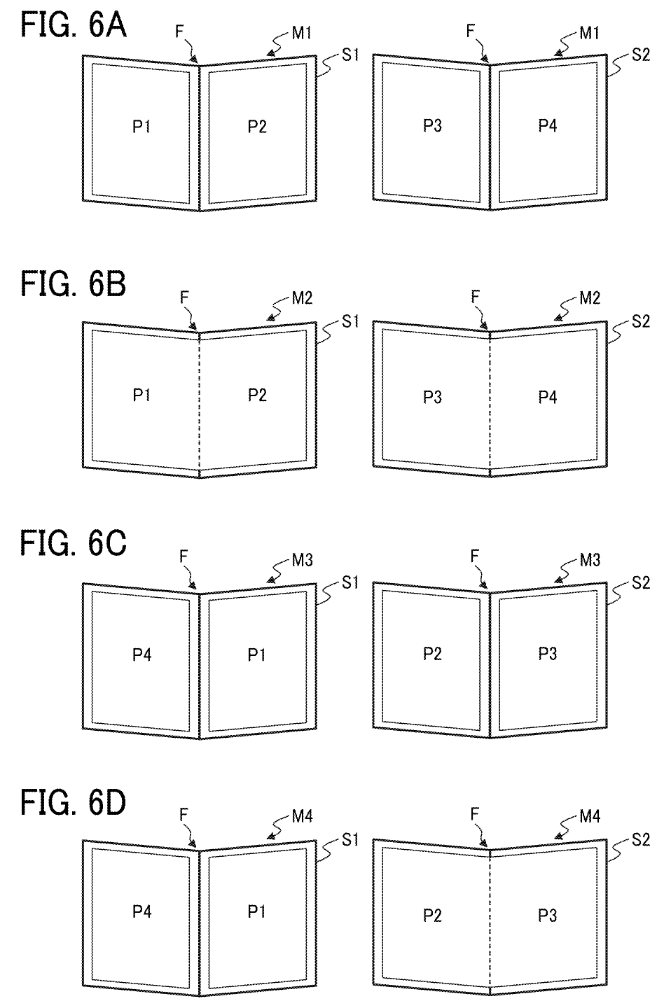

FIG. 6A is a schematic diagram illustrating a double-page spread medium M1 not including a continuous portion.

The size of the double-page spread medium M1 not including a continuous portion is larger than the maximum medium size supported by the scanner 100. The medium M1 is conveyed in a folded state at a fold line F. When opened, the medium M1 has a first surface S1 and a second surface S2 on the back side of the first surface S1. The first surface S1 includes a first page P1 on the left and a second page P2 on the right. The second surface S2 includes a third page P3 on the left and a fourth page P4 on the right. The image on the first page P1 and the image on the second page P2 are separated from each other, and the image on the third page P3 and the image on the fourth page P4 are separated from each other. Each of the surfaces S1 and S2A does not include a continuous portion at the fold line F.

First, the medium M1 is conveyed and imaged in a folded state with the first page P1 and the second page P2 on the outer side. Then, the medium M1 is conveyed and imaged in a folded state with the third page P3 and the fourth page P4 on the outer side. When the double-page spread combination setting is set to OFF for the medium M1, an input image representing the first page P1, an input image representing the second page P2, an input image representing the third page P3, and an input image representing the fourth page P4 are separately generated. When the data order setting is set to the normal order for the medium M1, the input images are arranged in the order of the input image representing the first page P1, the input image representing the second page P2, the input image representing the third page P3, and the input image representing the fourth page P4.

Referring back to FIG. 5, for the double-page spread medium including a continuous portion, the separation setting is set to the non-separation operation, the imaging surface setting is set to the double-sided imaging operation, the double-page spread combination setting is set to ON (both the first surface S1 and the second surface S2), and the data order setting is set to a first special order. In the first special order, an input image representing a first surface S1 including two pages of a double-page spread medium precedes an input image representing a second surface S2 including two pages of the spread medium.

FIG. 6B is a schematic diagram illustrating an example of a double-page spread medium M2 including a continuous portion.

The size of the double-page spread medium M2 including a continuous portion is larger than the maximum medium size supported by the scanner 100. The medium M2 is conveyed in a folded state at a fold line F. The medium M2 has a first surface S1 and a second surface S2 in an open state. The first surface S1 includes a first page P1 located leftward of the fold line F and a second page P2 located rightward of the fold line F. The second surface S2 includes a third page P3 located leftward of the fold line F and a fourth page P4 located rightward of the fold line F. An image on the first page P1 and an image on the second page P2 are continuous with each other, and an image on the third page P3 and an image on the fourth page P4 are continuous with each other. A continuous portion is present at the fold line F on each of the surfaces S1 and S2.

First, the medium M2 is conveyed and imaged in a folded state with the first page P1 and the second page P2 on the outer side. Then, the medium M2 is conveyed and imaged in a folded state with the third page P3 and the fourth page P4 on the outer side. When the double-page spread combination setting is set to ON for the medium M2, an input image in which the first page P1 and the second page P2 continuous with each other are combined and an input image in which the third page P3 and the fourth page P4 continuous with each other are combined are generated. When the data order setting is set to the first special order for the medium M2, the input images are arranged in the order of the input image in which the first page P1 and the second page P2 are combined and the input image in which the third page P3 and the fourth page P4 are combined.

Returning back to FIG. 5, for the booklet-shaped medium not including a continuous portion, the separation setting is set to the non-separation operation, the imaging surface setting is set to the double-sided imaging operation, the double-page spread combination setting is set to OFF, and the data order setting is set to a second special order. In the second special order, input images are arranged in the order of the input image representing the back side of a first surface S1, an input image representing the front side of a second surface S2, an input image representing the back side of the second surface S2, and an input image representing the front side of the first surface S1.

FIG. 6C is a schematic diagram illustrating a booklet-shaped medium M3 not including a continuous portion.

The size of the booklet-shaped medium M3 not including a continuous portion is larger than the maximum medium size supported by the scanner 100. The medium M3 is conveyed in a folded state at a fold line F. The medium M3 has a first surface S1 and a second surface S2 in an open state. The first surface S1 includes a first page P1 serving as the front cover of the medium M3 and a fourth page P4 serving as the back cover of the medium M3. The second surface S2 includes a second page P2 serving as the back side of the front cover of the medium M3 and a third page P3 serving as the back side of the back cover of the medium M3. On the first surface S1, the first page P1 is located rightward of the fold line F, and the fourth page P4 is located leftward of the fold line F. On the second surface S2, the second page P2 is located leftward of the fold line F, and the third page P3 is located rightward of the fold line F. An image on the first page P1 and an image on the fourth page P4 are separated from each other, and an image on the second page P2 and an image on the third page P3 are separated from each other. A continuous portion is not present at the fold line F on each of the surfaces S1 and S2.

First, the medium M3 is conveyed and imaged in a folded state with the first page P1 and the fourth page P4 on the outer side. Then, the medium M3 is conveyed and imaged in a folded state with the second page P2 and the third page P3 on the outer side. When the double-page spread combination setting is set to OFF for the medium M3, an input image representing the fourth page P4, an input image representing the first page P1, an input image representing the second page P2, and an input image representing the third page P3 are separately generated. When the data order setting is set to the second special order for the medium M3, the input images are arranged in the order of the input image representing the first page P1 (front cover), the input image representing the second page P2 (back side of front cover), the input image representing the third page P3 (back side of back cover), and the input image representing the fourth page P4 (back cover).

Returning back to FIG. 5, for the booklet-shaped medium including a continuous portion, the separation setting is set to the non-separation operation, the imaging surface setting is set to the double-sided imaging operation, the double-page spread combination setting is set to ON (only second surface S2), and the data order setting is set to a third special order. The third special order is an order in which an input image representing the back side of a first surface S1, an input image representing the front side and the back side of a second surface S2 are combined, and an input image representing the front side of the first surface S1 are arranged in this order.

FIG. 6D is a schematic diagram illustrating an example of a booklet-shaped medium M4 including a continuous portion.

The size of the booklet-shaped medium M4 including a continuous portion is larger than the maximum medium size supported by the scanner 100. The medium M4 is conveyed in a folded state at a fold line F. The medium M4 has a first surface S1 and a second surface S2 in an open state. The first surface S1 includes a first page P1 serving as the front cover of the medium M4 and a fourth page P4 serving as the back cover of the medium M4. The second surface S2 includes a second page P2 serving as the back side of the front cover of the medium M4 and a third page P3 serving as the back side of the back cover of the medium M4. On the first surface S1, the first page P1 is located rightward of the fold line F, and the fourth page P4 is located leftward of the fold line F. On the second surface S2, the second page P2 is located leftward of the fold line F, and the third page P3 is located rightward of the fold line F. An image on the first page P1 and an image on the fourth page P4 are separated from each other. A continuous portion is not present at the fold line F on the first surface S1. In contrast, an image on the second page P2 and an image on the third page P3 are continuous. A continuous portion is present at the fold line F on the second surface S2.

First, the medium M4 is conveyed and imaged in a folded state with the first page P1 and the fourth page P4 on the outer side. Then, the medium M4 is conveyed and imaged in a folded state with the second page P2 and the third page P3 on the outer side. When the double-page spread combination setting is set to ON (only second surface S2) for the medium M4, an input image representing the fourth page P4 and an input image representing the first page P1 are separately generated, and an input image representing the second page P2 and the third page P3 continuous to each other are imaged are generated. When the data order setting is set to the third special order for the medium M4, the input images are arranged in the order of the input image representing the first page P1 (front cover), the input image representing the second page P2 (back side of front cover) and the third page P3 (back side of back cover) are combined, and the input image representing the fourth page P4 (back cover).

While the right-opening booklet-shaped medium has been described as an example of the booklet-shaped medium having an overlapping portion, a left-opening booklet-shaped medium may be included in the type of the booklet-shaped medium having an overlapping portion instead of or in addition to the right-opening booklet-shaped medium. For the left-opening booklet-shaped medium not including a continuous portion, the data order setting is set to an order in which an input image representing the front side of a first surface S1, an input image representing the back side of a second surface S2, an input image representing the front side of the second surface S2, and an input image representing the back side of the first surface S1 are arranged in this order. For the left-opening booklet-shaped medium including a continuous portion, the data order setting is set to an order in which an input image representing the front side of a first surface S1, an input image in which the front side and the back side of a second surface S2 are combined, and an input image representing the back side of the first surface S1 are arranged in this order.

The setting relating to the conveyance process may include a setting of a conveyance speed of a medium. For example, the conveyance speed of the medium with an attachment, the envelope, the medium to which a copy sheet is attached, the double-page spread medium, and/or the booklet-shaped medium is set to a speed lower than the conveyance speed of the normal medium. Accordingly, the scanner 100 can reduce displacement of an overlapping portion of a medium having an overlap while the medium is fed. The conveyance speed of the medium with an attachment and/or the medium to which a copy sheet is attached may be set to a speed lower than the conveyance speed of the envelope, the double-page spread medium, or the booklet-shaped medium. Accordingly, the scanner 100 can reduce detachment of the attachment or the copy sheet from the medium while the medium is fed.

The setting relating to the imaging process may include settings of a gradation range and a color (color, grayscale, or binary). For example, the color of the medium with an attachment is set to color. Typically, an attachment has a certain color. When the color of the medium with an attachment is set to the color, the user can satisfactorily identify the attachment in the input image representing the medium with the attachment. For example, the gradation range for the booklet-shaped medium is set to a range larger than the gradation range for the normal medium. Typically, a photograph is highly likely to be printed on a booklet-shaped medium such as a pamphlet or a catalog, and the scanner 100 can store the photograph printed on the booklet-shaped medium with high image quality by increasing the gradation range for the booklet-shaped medium.

The settings relating to the image processing may include settings such as whether to perform gradation correction and whether to perform noise removal. For example, the gradation correction or the noise removal is set to be performed for the booklet-shaped medium. Typically, a photograph is highly likely to be printed on a booklet-shaped medium such as a pamphlet or a catalog, and the scanner 100 can store the photograph printed on the booklet-shaped medium with high image quality by performing the gradation correction or the noise removal.

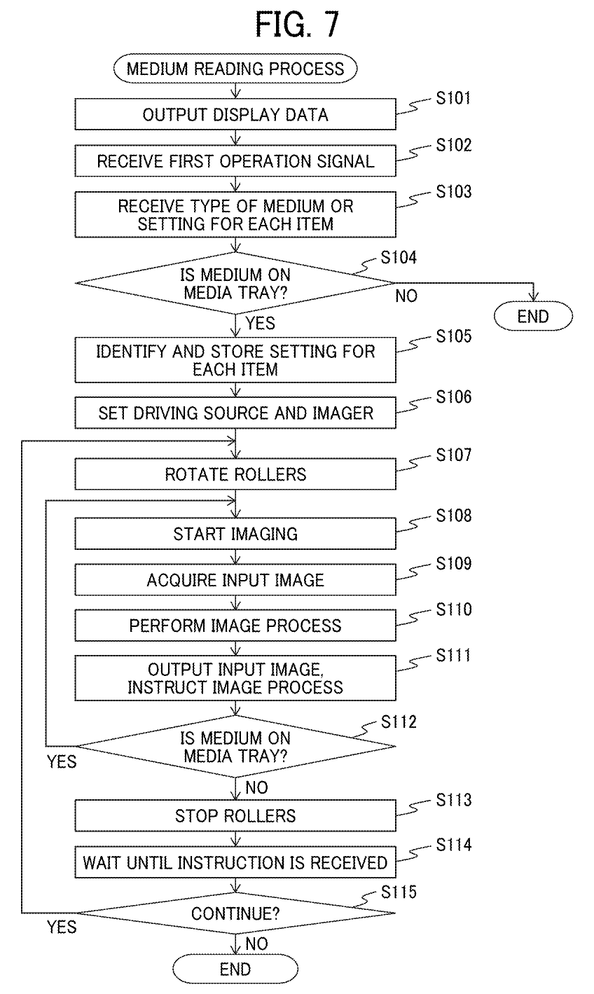

FIG. 7 is a flowchart presenting an example of an operation of a medium reading process performed by the scanner 100.

The example of the operation of the medium reading process of the scanner 100 will be described below with reference to the flowchart in FIG. 7. The sequence of the operation described below is executed, for example, by the first processing circuit 140 in cooperation with each component of the scanner 100 based on a program stored in the first memory 130 in advance.

In step S101, the output control unit 141 generates and outputs display data for displaying the type of a medium to be conveyed in a manner selectable by the user. The type of the medium to be conveyed includes a type of a medium having an overlapping portion. For example, the output control unit 141 outputs the display data by displaying the display data on the display and operation device 105.

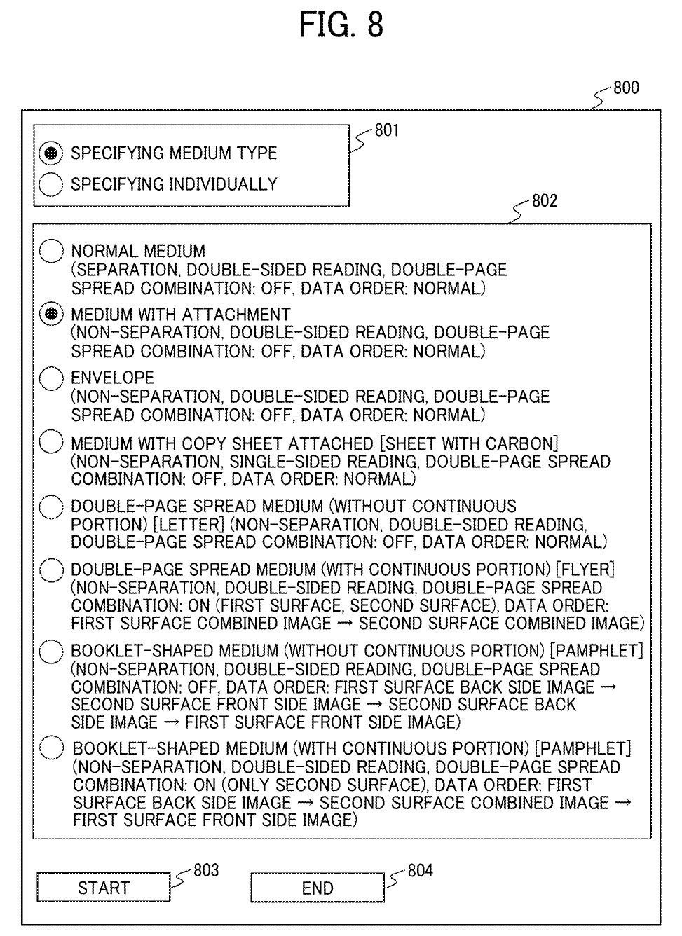

FIG. 8 is a schematic diagram illustrating display data 800.

As illustrated in FIG. 8, the display data 800 includes a specifying method selection object 801, a medium type selection object 802, a start button 803, and an end button 804. The specifying method selection object 801 is an object for selecting whether to specify the settings relating to the conveyance process, the imaging process, and/or the image processing based on the type of the medium to be conveyed, or to individually specify the settings. The medium type selection object 802 is an object for specifying the type of the medium to be conveyed. The medium type selection object 802 is displayed when specifying settings based on the type of medium is selected in the specifying method selection object 801. In the medium type selection object 802, a normal medium and multiple types of media having overlapping portions are displayed in a selectable manner. With the types of media being displayed in a selectable manner, the user can appropriately select the type of the medium to be conveyed from the displayed types. In the medium type selection object 802, an example of each type (sheet with carbon, letter, flyer, or pamphlet) may be displayed together with the type. With the example of each type being displayed, the user can correctly select the type of the medium to be conveyed. In the medium type selection object 802, an image (an icon or an image obtained by reading the medium) indicating the medium of each type may be displayed together with the type. With the image corresponding to each type being displayed, the user can visually recognize the type of the medium to be conveyed. In the medium type selection object 802, a setting corresponding to each type may be displayed together with the type. With the setting corresponding to each type being displayed, the user can recognize the content of the process to be performed when the type is selected. The start button 803 is a button for giving an instruction to start conveyance of the medium and imaging. The end button 804 is a button for ending the display of the display data 800.

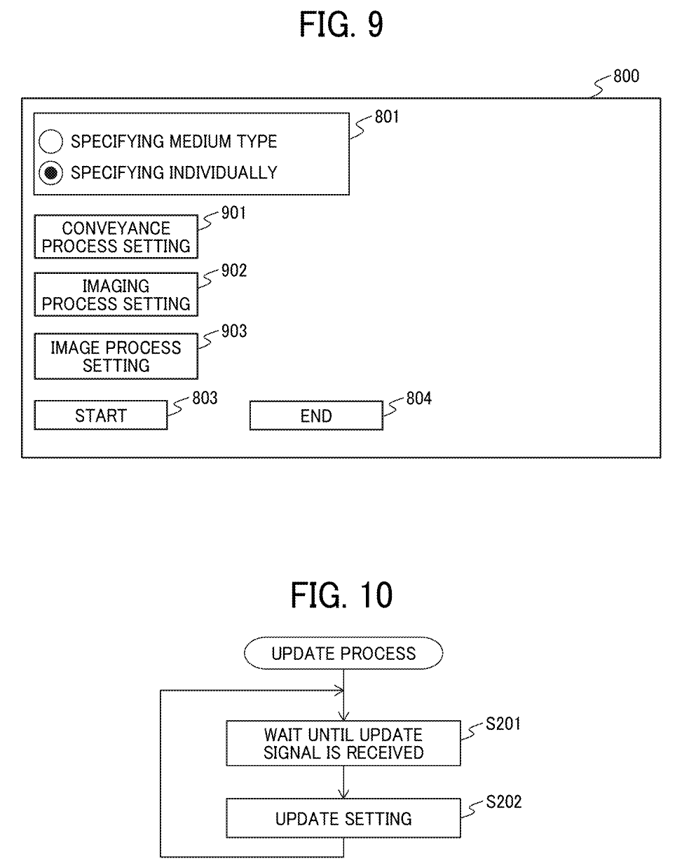

FIG. 9 is a schematic diagram illustrating an example of display data 800 displayed when the specifying settings individually is selected in the specifying method selection object 801.

As illustrated in FIG. 9, when the specifying settings individually is selected in the specifying method selection object 801, a conveyance process setting button 901, an imaging process setting button 902, and an image processing setting button 903 are displayed instead of the medium type selection object 802. The conveyance process setting button 901 is a button for individually specifying settings (separation setting and conveyance speed setting) relating to the conveyance process for each item. When the conveyance process setting button 901 is pressed, a setting screen for individually specifying the settings relating to the conveyance process is displayed. The imaging process setting button 902 is a button for individually specifying settings (imaging surface setting, gradation range setting, and color setting) relating to the imaging process for each item. When the imaging process setting button 902 is pressed, a setting screen for individually specifying the settings relating to the imaging process is displayed. The image processing setting button 903 is a button for individually specifying settings (double-page spread combination setting, data order setting, gradation correction setting, and noise removal setting) relating to the image processing for each item. When the image processing setting button 903 is pressed, a setting screen for individually specifying the settings relating to the image processing is displayed.

When the start button 803 is pressed, the display and operation device 105 outputs a first operation signal for instructing reading of a medium to the first processing circuit 140. When specifying settings based on the type of medium is selected in the specifying method selection object 801, the first operation signal includes the type specified in the medium type selection object 802. In contrast, when the specifying settings individually is selected in the specifying method selection object 801, the first operation signal includes the setting relating to the conveyance process, the imaging process, and/or the image processing individually specified in each setting screen.

The output control unit 141 may output display data by transmitting the display data to the information processing apparatus 200 via the first communication device 122. In this case, the second processing circuit 220 of the information processing apparatus 200 receives the display data via the second communication device 203, and displays the received display data on the display device 201. Alternatively, the second processing circuit 220 of the information processing apparatus 200 may include an output control unit similar to the output control unit 141, and the output control unit may generate display data and display the display data on the display device 201.

When the start button 803 is pressed by the user using the display and operation device 105 or the information processing apparatus 200, in step S102, the reception unit 142 receives the first operation signal from the display and operation device 105 or the first communication device 122.

In step S103, the reception unit 142 identifies the type of medium specified by the user or the setting relating to the conveyance process, the imaging process, and/or the image processing included in the first operation signal, and receives the identified type of medium or the identified setting relating to each process. In this way, the reception unit 142 receives the specification indicating the type of the medium having an overlapping portion.

In step S104, the control unit 143 obtains a media signal from the media sensor 111 and determines whether a medium is placed on the media tray 103 based on the obtained media signal. The control unit 143 ends the series of steps when no medium is placed on the media tray 103.

In contrast, when a medium is placed on the media tray 103, in step S105, the control unit 143 identifies the setting relating to the conveyance process, the imaging process, and/or the image processing, and stores the setting in the first memory 130. When the reception unit 142 receives the specification indicating the type of medium, the control unit 143 refers to the setting table and identifies the setting relating to the conveyance process, the imaging process, and/or the image processing corresponding to the type of medium received by the reception unit 142. In contrast, when the reception unit 142 receives the setting relating to each process, the control unit 143 identifies the setting received by the reception unit 142 as the setting relating to the conveyance process, the imaging process, and/or the image processing.

In step S106, the control unit 143 sets the driving source 121 according to the identified setting relating to the conveyance process, and sets the imaging device 116 according to the identified setting relating to the imaging process. When the separation operation is specified in the separation setting, the control unit 143 sets the operation mode to the separation mode, and sets the driving source 121 such that the separation roller 113 rotates in the direction A5 opposite the medium feeding direction, or is kept stationary. In contrast, when the non-separation operation is specified in the separation setting, the control unit 143 sets the operation mode to the non-separation mode and sets the driving source 121 such that the separation roller 113 rotates following the feed roller 112. The control unit 143 sets the rotation speed of the driving source 121 such that each roller rotates at the speed specified in the conveyance speed setting. When the double-sided imaging operation is specified in the imaging surface setting, the control unit 143 sets the imaging device 116 to cause both the first imaging device 116a and the second imaging device 116b to perform imaging. In contrast, when the single-sided imaging operation is specified in the imaging surface setting, the control unit 143 sets the imaging device 116 to cause only the first imaging device 116a to perform imaging. The control unit 143 sets the gradation range of the imaging device 116 to generate an input image in the gradation range specified in the gradation range setting, and sets the imaging sensors for the respective colors of RGB of the imaging device 116 to generate an input image with the colors specified in the color setting.

In step S107, the control unit 143 controls the driving source 121 to rotate the rollers to convey the medium. The control unit 143 controls the driving source 121 to rotate the feed roller 112, the separation roller 113, the first conveyance roller 114, the second conveyance roller 115, the first ejection roller 117, and/or the second ejection roller 118 according to the setting in step S106. In this way, the control unit 143 controls the conveyor according to the type received by the reception unit 142.

In particular, the control unit 143 changes whether to cause the conveyor to separate the medium according to the type received by the reception unit 142. The user may not have sufficient knowledge about the conveyance process and may not correctly recognize whether the medium to be conveyed is a medium to be separated or a medium not to be separated. Having the user specify the type of the medium to be conveyed, the scanner 100 can appropriately determine whether to separate the medium.

In step S108, the control unit 143 controls the imaging device 116 to start imaging the medium. The control unit 143 causes the imaging device 116 to image the medium according to the setting in step S106. In this way, the control unit 143 controls the imaging device 116 according to the type received by the reception unit 142.

In step S109, the control unit 143 acquires the input image from the imaging device 116, and causes the imaging device 116 to end imaging of the medium.

In step S110, the control unit 143 performs the image processing on the acquired input image. The control unit 143 performs the image processing on the input image according to the setting relating to the image processing identified in step S105. In this way, the control unit 143 performs the image processing on the input image according to the type received by the reception unit 142.

In particular, the control unit 143 performs the double-page spread combination process on the input image according to the type received by the reception unit 142. The user may not have sufficient knowledge about the combination process, and may not correctly recognize whether the medium to be conveyed is a medium on which the combination process is to be performed or a medium on which the combination process is not to be performed. Having the user specify the type of the medium to be conveyed, the scanner 100 can appropriately perform the combination process.

The control unit 143 rearranges the input images according to the type received by the reception unit 142. The user may not sufficiently understand the order in which the media are imaged by the scanner 100, and may not correctly recognize in what order the input images representing the media to be conveyed are imaged are to be rearranged. Having the user specify the type of the medium to be conveyed, the scanner 100 can arrange the input images in an appropriate order.

In step S111, the control unit 143 transmits the input image on which the image processing is performed to the information processing apparatus 200 via the first communication device 122. The control unit 143 may transmit the input image on which the image processing is not performed to the information processing apparatus 200 without performing the image processing on the input image in step S110. In this case, the control unit 143 may transmit a request signal for requesting execution of the image processing on the input image according to the setting relating to the image processing identified in step S105 to the information processing apparatus 200 via the first communication device 122 together with the input image. That is, the control unit 143 instructs the external device on the content of the image processing to be performed on the input image according to the type received by the reception unit 142. When receiving the input image and the request signal via the second communication device 203, the second processing circuit 220 of the information processing apparatus 200 performs the image processing on the input image according to the setting specified in the request signal.

When the second special order or the third special order is specified in the data order setting, the control unit 143 may skip the processes of steps S110 and S111 until two input images are acquired. In this case, when acquiring two input images, the control unit 143 performs the process in step S110 to rearrange the input images, and then performs the process in step S111 to transmit the input images to the information processing apparatus 200.

In step S112, the control unit 143 determines whether a medium remains on the media tray 103 based on the media signal received from the media sensor 111. When a medium remains on the media tray 103, the control unit 143 returns the process to step S108 and repeats the processes of steps S108 to S112.

In contrast, when no medium remains on the media tray 103, in step S113, the control unit 143 controls the driving source 121 to stop the rollers. The control unit 143 controls the driving source 121 to stop the feed roller 112, the separation roller 113, the first conveyance roller 114, the second conveyance roller 115, the first ejection roller 117, and/or the second ejection roller 118.

In step S114, the control unit 143 waits until an instruction on whether to continue the medium reading process is received from the user. When an end instruction or a continuation instruction is input by the user using the display and operation device 105 or the information processing apparatus 200 and an instruction signal is received from the display and operation device 105 or the first communication device 122, or when it is detected that a new medium is placed on the media tray 103 based on the media signal, the control unit 143 determines that the instruction on whether to continue the medium reading process is received. The instruction signal indicates one of the end instruction and the continuation instruction.

In step S115, the control unit 143 determines whether to continue the medium reading process. When the instruction signal indicating the continuation instruction is received or when it is detected that a new medium is placed on the media tray 103, the control unit 143 determines to continue the medium conveyance. In this case, the control unit 143 returns the process to step S107 and repeats the processes in step S107 and the subsequent steps. In contrast, when the instruction signal indicating the end instruction is received, the control unit 143 determines not to continue the medium conveyance and ends the series of steps. At this time, when the processes in steps S110 and S111 are skipped and there is an input image not transmitted to the information processing apparatus 200 yet, the control unit 143 transmits the input image not transmitted to the information processing apparatus 200 yet via the first communication device 122.

The process in step S101 may be omitted. The process in step S103 may be performed after the process in step S104. The process in step S105 may be performed before the process in step S104.

FIG. 10 is a flowchart presenting an example of an operation of an update process performed by the scanner 100.

The example of the operation of the update process of the scanner 100 will be described below with reference to the flowchart in FIG. 10. The sequence of the operation described below is executed, for example, by the first processing circuit 140 in cooperation with each component of the scanner 100 based on a program stored in the first memory 130 in advance.

In step S201, the second reception unit 144 waits until an update signal is received from the display and operation device 105 or the first communication device 122. The update signal is a signal for giving an instruction to update the setting relating to the conveyance process, the imaging process, or the image processing corresponding to the type of medium. The update signal includes the type of medium to be updated and the operation of the conveyor, the operation of the imaging device 116, or the content of the image processing when the medium of the type is conveyed. The operation of the conveyor includes the separation operation or the non-separation operation, and the conveyance speed. The operation of the imaging device 116 includes the double-sided imaging operation or the single-sided imaging operation, the gradation range, and the color. The image processing includes whether to combine an input image representing the front side of the medium and an input image representing the back side of the medium, the order in which the input images generated by the imaging device 116 are arranged, whether to perform the gradation correction, and whether to perform the noise removal. The type of medium to be updated, and the operation of the conveyor, the operation of the imaging device 116, or the content of the image processing when the medium of the type is conveyed are specified by the user using the display and operation device 105 or the information processing apparatus 200. In this way, the second reception unit 144 receives the specification indicating the operation of the conveyor, the operation of the imaging device 116, or the content of the image processing corresponding to the type of the medium having an overlapping portion.

In step S202, the second reception unit 144 updates the setting table according to the received specification, and returns the process to step S201. The second reception unit 144 updates the content of each setting corresponding to the type of medium specified in the update signal to the operation of the conveyor, the operation of the imaging device 116, and/or the content of the image processing specified in the update signal in the setting table. With this configuration, the scanner 100 can customize the operation of the conveyor, the operation of the imaging device 116, and/or the content of the image processing corresponding to the type of each medium according to the purpose of each user, and can increase the convenience of the user.

The update process may be omitted.

As described above in detail, the scanner 100 receives the specification indicating the type of the medium having an overlapping portion, and controls the conveyor or the imaging device 116 or performs the image processing according to the received type. The user may not have sufficient knowledge about the conveyance process, the imaging process, or the image processing, and may not correctly recognize the conveyance process, the imaging process, or the image processing to be performed on the medium to be conveyed. Having the user specify the type of the medium to be conveyed, the scanner 100 can appropriately determine the conveyance process, the imaging process, or the image processing to be performed on the medium to be conveyed. Thus, the scanner 100 can appropriately control the conveyor or the imaging device 116, or can appropriately perform the image processing on the input image.

Having the user specify the type of the medium having an overlapping portion, the user can collectively change multiple settings relating to the conveyance process, the imaging process, or the image processing, and the scanner 100 increases the convenience of the user. In particular, a typical imager has various types of settings to support various types of media. In the imager, it is difficult to consolidate various setting screens into one screen, so the user has to navigate through multiple screens to perform the various settings. The scanner 100 allows the user to complete the settings in one screen by merely specifying the type of medium. Thus, the scanner 100 increases the convenience of the user.

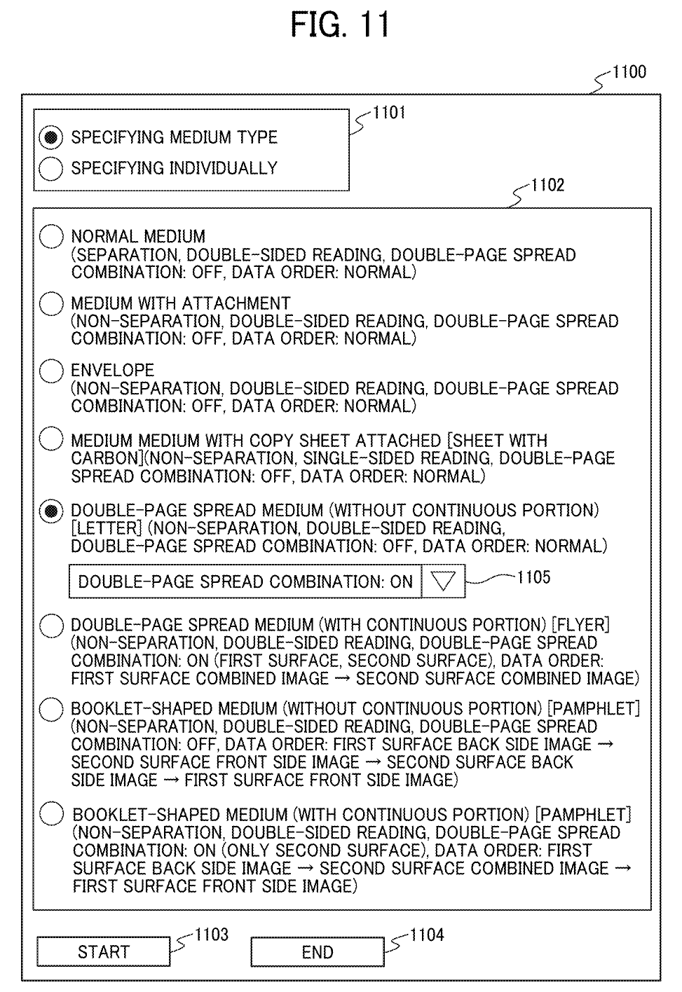

FIG. 11 is a schematic diagram illustrating an example of display data 1100 generated by another imager.

The display data 1100 illustrated in FIG. 11 is generated and displayed instead of the display data 800 illustrated in FIG. 8 in the process in step S101 in FIG. 7. As illustrated in FIG. 11, the display data 1100 includes a specifying method selection object 1101, a medium type selection object 1102, a start button 1103, and an end button 1104. The specifying method selection object 1101 is an object similar to the specifying method selection object 801. The medium type selection object 1102 is an object similar to the medium type selection object 802. However, a specifying box 1105 is displayed in the medium type selection object 1102. The specifying box 1105 is set in advance for each medium type, and when one medium type is selected, the specifying box 1105 corresponding to the specified medium type is displayed. In the specifying box 1105, at least one of settings relating to the conveyance process, the imaging process, or the image processing corresponding to the specified medium type is displayed in a selectable manner. The setting displayed in the specifying box 1105 in a selectable manner is, for example, a setting for which a different operation may be performed according to the purpose of each user, such as the imaging surface setting, the double-page spread combination setting, and/or the data order setting. For example, even when a double-page spread medium or a booklet-shaped medium does not include a continuous portion, two pages arranged side by side may be highly related to each other. For example, the page located on one side of the fold may contain a figure, and the page located on the other side may contain the explanation of that figure. When the specifying box 1105 is displayed, the user can flexibly change at least one of the settings corresponding to the type of the medium to be conveyed. The start button 1103 is a button similar to the start button 803. The end button 1104 is a button similar to the end button 804.

When the start button 1103 is pressed, the display and operation device 105 outputs the first operation signal to the first processing circuit 140. When specifying settings based on the type of medium is selected in the specifying method selection object 1101, the first operation signal includes the setting specified in the specifying box 1105 corresponding to the type in addition to the type specified in the medium type selection object 1102. In this case, in step S103, the reception unit 142 identifies the type of medium specified by the user, and the setting relating to the conveyance process, the imaging process, and/or the image processing included in the first operation signal, and receives the identified type of medium and the setting relating to each process. In this way, the reception unit 142 receives the specification indicating the type of the medium having an overlapping portion and the setting relating to the conveyance process, the imaging process, and/or the image processing corresponding to the specified type.

In this case, in step S105, the control unit 143 refers to the setting table and identifies the setting relating to the conveyance process, the imaging process, and/or the image processing according to the type of medium received by the reception unit 142. However, for the setting included in the first operation signal, the control unit 143 identifies the setting included in the first operation signal as the setting relating to the conveyance process, the imaging process, and/or the image processing instead of the setting read from the setting table. By having the user specify the type of medium to be conveyed and individually specify any settings whose required operation may vary depending on the user’s purpose, the scanner 100 can appropriately determine the process to be performed on the medium to be conveyed.

As described above in detail, even when the scanner 100 receives the specification indicating the type of the medium having an overlapping portion and the setting corresponding to the specified type, the scanner 100 can appropriately control the conveyor or the imaging device 116 or appropriately perform the image processing on the input image.

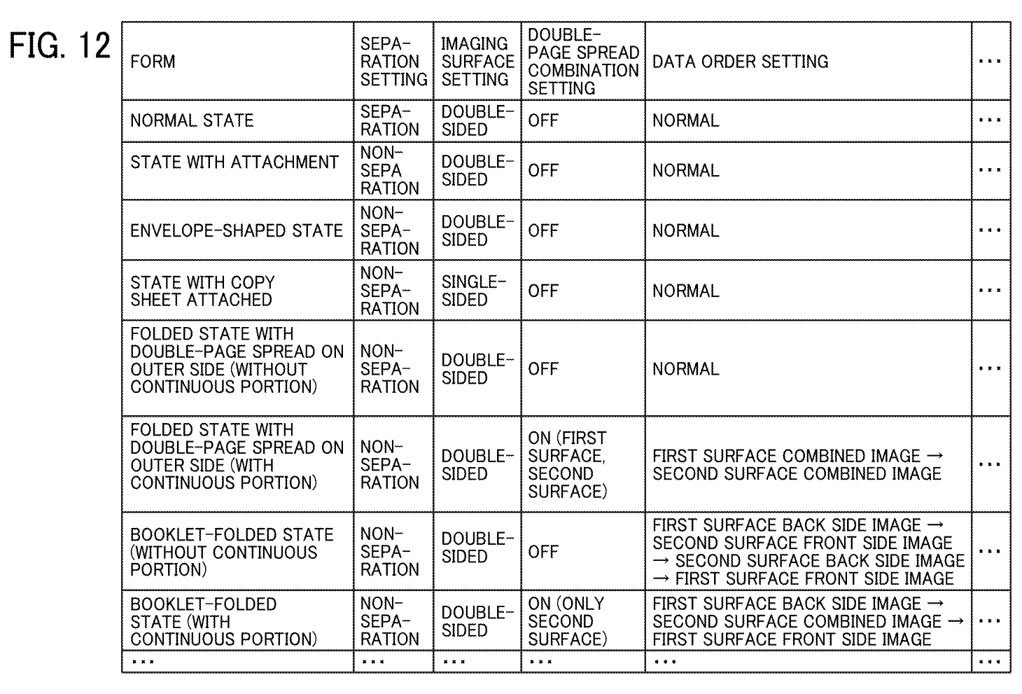

FIG. 12 is a table presenting an example of a data structure of a setting table stored in another imager.

The setting table presented in FIG. 12 is used instead of the setting table presented in FIG. 5.

As presented in FIG. 12, for each state (form) of medium, settings corresponding to the state (form) are stored in advance in the setting table. The state of medium includes a shape, a property, and a feature of medium. The medium may be in various states, including a normal state, a state with an attachment, an enclosed state (like an envelope), a state with a copy sheet attached, or a folded state. The normal state is a state not having an overlapping portion. The folded state is, for example, a two folded state, and includes a folded state with a double-page spread on the outer side, or a booklet folded state. The state with an attachment, the enclosed state, the state with a copy sheet attached, the folded state with a double-page spread on the outer side, and the folded state into a booklet correspond to the medium with an attachment, the envelope, the medium with a copy sheet attached, the double-page spread medium, and the booklet-shaped medium, respectively. The scanner 100 manages the setting for each of these states. Thus, the scanner 100 or the information processing apparatus 200 can be appropriately controlled when a medium in one of these states is conveyed. The folded state with a double-page spread on the outer side or the booklet folded state includes a state including a continuous portion or a state not including a continuous portion. The state including a continuous portion and the state not including a continuous portion correspond to the medium including a continuous portion and the medium not including a continuous portion, respectively. The scanner 100 manages the setting for each of the medium including a continuous portion and the medium not including a continuous portion. Thus, the scanner 100 or the information processing apparatus 200 can be appropriately controlled depending on whether the medium includes a continuous portion.

The settings for each state are set in the same or substantially the same manner as the settings for the type corresponding to the state.

Also in this case, the medium reading process presented in FIG. 7 is performed. However, in step S101, the output control unit 141 generates and outputs display data for displaying the state of the medium to be conveyed in a manner selectable by the user.

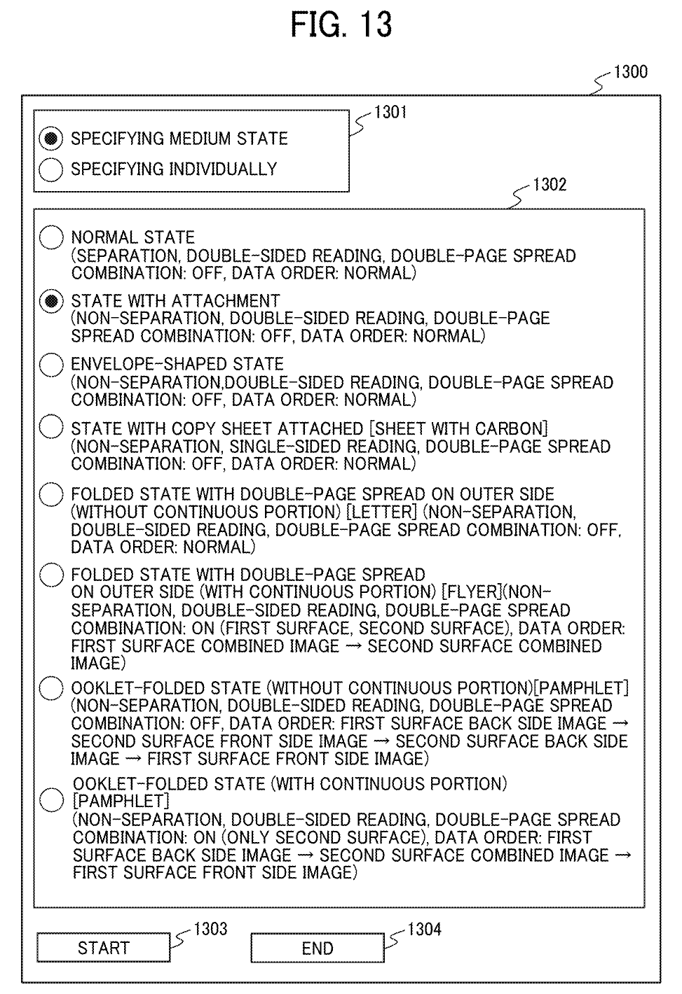

FIG. 13 is a schematic diagram illustrating an example of display data 1300.

As illustrated in FIG. 13, the display data 1300 includes a specifying method selection object 1301, a medium state selection object 1302, a start button 1303, and an end button 1304. The specifying method selection object 1301 is an object for selecting whether to specify the settings relating to the conveyance process, the imaging process, and/or the image processing based on the state of the medium to be conveyed or to individually specify the settings. The medium state selection object 1302 is an object for specifying the state of the medium to be conveyed. The medium state selection object 1302 is displayed when the specifying settings based on the medium state is selected in the specifying method selection object 1301. In the medium state selection object 1302, a normal state and multiple states of media having overlapping portions are displayed in a selectable manner. Displaying the state of medium in a selectable manner allows the user to appropriately specify the state of the medium to be conveyed from the displayed states. In the medium state selection object 1302, respective examples of the states (sheet with carbon, letter, flyer, or pamphlet) may be displayed together with the state. Displaying the examples of the states allows the user to correctly select the state of the medium to be conveyed. In the medium state selection object 1302, a setting corresponding to each state may be displayed together with the state. Displaying the setting corresponding to each state allows the user to recognize the content of the process to be performed when the state is selected. The start button 1303 is a button similar to the start button 803. The end button 1304 is a button similar to the end button 804.

When one of the states of media is selected, a specifying box corresponding to the specified state of medium may be displayed in the display data 1300 as in the display data 1100 illustrated in FIG. 11. In this case, when the specification based on the state of medium is selected in the specifying method selection object 1301, the first operation signal includes the setting specified in the specifying box corresponding to the state in addition to the state specified in the medium state selection object 1302.

In step S103, the reception unit 142 receives the specification indicating a state of a medium having an overlapping portion and/or a setting relating to the conveyance process, the imaging process, or the image processing corresponding to the specified state. When the reception unit 142 receives the specification indicating the medium state, in step S105, the control unit 143 identifies the setting relating to the conveyance process, the imaging process, and/or the image processing according to the medium state received by the reception unit 142. In step S107, the control unit 143 controls the conveyor according to the state received by the reception unit 142, and particularly changes whether to cause the conveyor to separate the medium. In step S108, the control unit 143 controls the imaging device 116 according to the state received by the reception unit 142. In step S110, the control unit 143 performs the image processing on an input image according to the state received by the reception unit 142, and particularly performs the double-page spread combination process on input images or rearranges the input images. In step S111, the control unit 143 instructs the external device on the content of the image processing to be performed on the input image according to the state received by the reception unit 142.

Also in this case, the update process presented in FIG. 10 is performed. However, in step S201, the second reception unit 144 receives the specification indicating the operation of the conveyor, the operation of the imaging device 116, or the content of the image processing corresponding to the state of the medium having an overlapping portion.

As described above in detail, the scanner 100 receives the specification indicating the state of the medium having an overlapping portion, and controls the conveyor or the imaging device 116, or performs the image processing according to the received state. With the user specifying the state of the medium to be conveyed, the scanner 100 can appropriately determine the conveyance process, the imaging process, or the image processing to be performed on the medium to be conveyed. Thus, the scanner 100 can appropriately control the conveyor or the imaging device 116, or can appropriately perform the image processing on the input image.

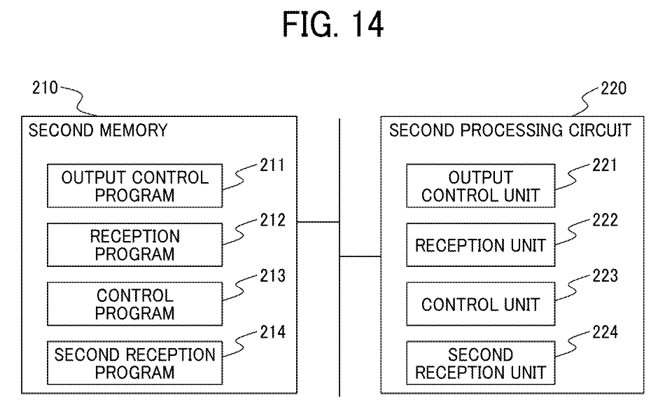

FIG. 14 is a diagram illustrating schematic configurations of a second memory 210 and a second processing circuit 220 of another information processing apparatus.

In the image processing system 1, instead of the scanner 100, the information processing apparatus 200 receives the specification indicating one of the type and the state of a medium having an overlapping portion from the user. The second memory 210 of the information processing apparatus 200 stores the setting table presented in FIG. 5 or 12 as data.

As illustrated in FIG. 14, the second memory 210 stores an output control program 211, a reception program 212, a control program 213, and a second reception program 214. These programs are functional modules implemented by software to operate on the processor. The second processing circuit 220 reads the programs from the second memory 210 and operates according to the read programs. Accordingly, the second processing circuit 220 functions as an output control unit 221, a reception unit 222, a control unit 223, and a second reception unit 224. The output control unit 221, the reception unit 222, the control unit 223, and the second reception unit 224 function in the same or substantially the same manner as the output control unit 141, the reception unit 142, the control unit 143, and the second reception unit 144, respectively.

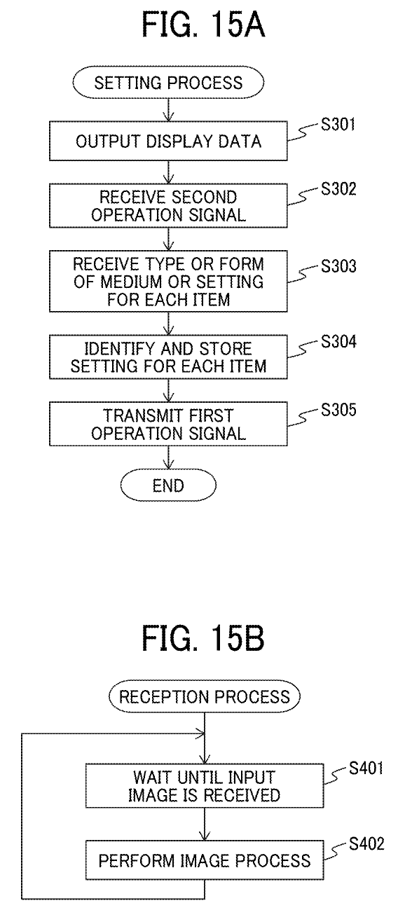

FIG. 15A is a flowchart presenting a setting process performed by the information processing apparatus 200.

The example of the operation of the setting process performed by the information processing apparatus 200 is described below with reference to the flowchart in FIG. 15A. The flow of the operation described below is executed, for example, by the second processing circuit 220 in cooperation with each component of the information processing apparatus 200 based on a program stored in the second memory 210 in advance.

In step S301, the output control unit 221 generates display data similar to the display data displayed in step S101, that is, display data for displaying the type or the state of the medium having an overlapping portion in a selectable manner, and outputs the display data by displaying the display data on the display device 201. However, in this case, when the start button is pressed in each display data, the operation device 202 outputs a second operation signal for instructing reading of a medium to the second processing circuit 220. When specification based on the type or the medium state is selected in the specifying method selection object, the second operation signal includes the type or the state specified in the medium type selection object or the medium state selection object and/or a setting corresponding to the type or the state. In contrast, when the specifying settings individually is selected in the specifying method selection object, the second operation signal includes a setting individually specified in each setting screen.

When the start button is pressed by the user using the operation device 202, in step S302, the reception unit 222 receives the second operation signal from the operation device 202.

In step S303, the reception unit 222 identifies the type or the medium state specified by the user and/or the setting relating to the conveyance process, the imaging process, and/or the image processing included in the second operation signal, and receives the identified type or medium state or the identified setting relating to each process. In this way, the reception unit 142 receives the type or the state of the medium having an overlapping portion and/or the setting relating to the conveyance process, the imaging process, or the image processing corresponding to the specified type or state.

In step S304, the control unit 223 identifies the setting relating to the conveyance process, the imaging process, and/or the image processing, and stores the setting in the second memory 210. When the reception unit 222 receives the specification indicating the type or the medium state, the control unit 223 refers to the setting table and identifies the setting relating to the conveyance process, the imaging process, and/or the image processing corresponding to the type or the medium state received by the reception unit 222. When the second operation signal includes the setting relating to the conveyance process, the imaging process, and/or the image processing corresponding to the type or the medium state, the control unit 223 identifies, for the setting, the setting included in the second operation signal as the setting relating to the conveyance process, the imaging process, and/or the image processing instead of the setting read from the setting table. In contrast, when the reception unit 222 receives the setting relating to each process, the control unit 223 identifies the setting received by the reception unit 222 as the setting relating to the conveyance process, the imaging process, and/or the image processing.

In step S305, the control unit 223 generates a first operation signal, transmits the first operation signal to the scanner 100 via the second communication device 203, and ends the series of steps. The first operation signal includes the setting relating to the conveyance process, the imaging process, and/or the image processing identified in step S304. In step S102 in FIG. 7, the reception unit 142 of the scanner 100 receives the first operation signal from the information processing apparatus 200 via the first communication device 122, and performs the processes in step S103 and the subsequent steps according to the setting specified in the first operation signal. That is, in this case, in step S105, the control unit 143 of the scanner 100 identifies the setting specified in the first operation signal as the setting relating to the conveyance process, the imaging process, and/or the image processing. In this way, the control unit 223 instructs the scanner on the operation of the conveyor, the operation of the imaging device, or the content of the image processing to be performed on the input image according to the type or the state received by the reception unit 222.

FIG. 15B is a flowchart presenting a reception process performed by the information processing apparatus 200.

The example of the operation of the reception process performed by the information processing apparatus 200 is described below with reference to the flowchart in FIG. 15B. The flow of the operation described below is executed, for example, by the second processing circuit 220 in cooperation with each component of the information processing apparatus 200 based on a program stored in the second memory 210 in advance.

In step S401, the control unit 223 waits until an input image is received from the scanner 100. When the control unit 143 of the scanner 100 transmits an input image to the information processing apparatus 200 in step S111 in FIG. 7, the control unit 223 receives the input image from the scanner 100 via the second communication device 203.

In step S402, the control unit 223 performs the image processing on the received input image, and returns the process to step S401. In step S110 in FIG. 7, when the control unit 143 of the scanner 100 performs the image processing on the input image according to the setting relating to the image processing identified in step S304 in FIG. 15A, the process in step S402 is omitted. In contrast, when the control unit 143 of the scanner 100 does not perform the image processing on the input image, the control unit 223 of the information processing apparatus 200 performs the image processing on the input image according to the setting relating to the image processing identified in step S304 in FIG. 15A. In this way, the control unit 223 performs the image processing on the input image according to the type or the state received by the reception unit 222. In particular, the control unit 223 performs the double-page spread combination process on the input image according to the type received by the reception unit 222. The control unit 223 rearranges the input images according to the type received by the reception unit 222. The control unit 223 stores the input image on which the image processing is performed in the second memory 210 and/or displays the input image on the display device 201.

The second reception unit 224 performs the update process in FIG. 10. In step S201, the second reception unit 224 receives the specification indicating the operation of the conveyor, the operation of the imaging device 116, or the content of the image processing corresponding to the type or the state of the medium having an overlapping portion specified by the user using the operation device 202. In step S202, the second reception unit 224 updates the setting table stored in the second memory 210 according to the received specification.

As described above in detail, the information processing apparatus 200 receives the specification indicating the type or the state of the medium having an overlapping portion. The information processing apparatus 200 performs the image processing on the input image or instructs the scanner 100 on the operation of the conveyor, the operation of the imaging device 116, or the content of the image processing to be performed on the input image according to the received type or state. Having the user specify the type or the state of the medium to be conveyed, the information processing apparatus 200 can appropriately determine the conveyance process, the imaging process, or the image processing to be performed on the medium to be conveyed. Thus, the information processing apparatus 200 can appropriately control the conveyor or the imaging device 116 of the scanner 100, or can appropriately perform the image processing on the input image.

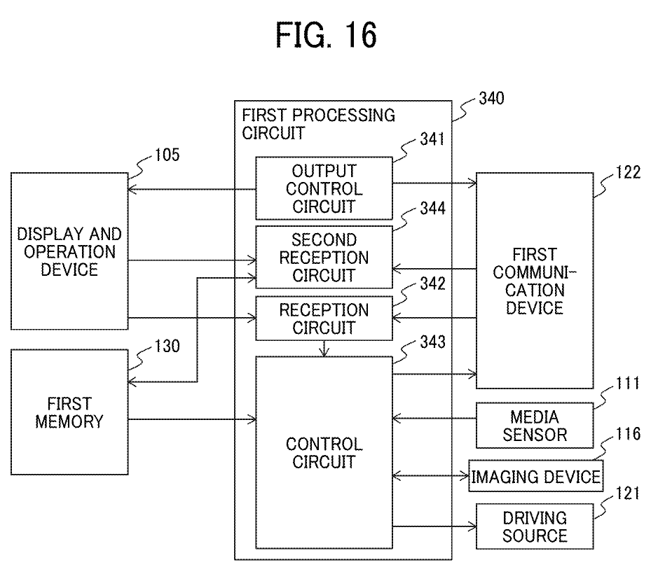

FIG. 16 is a diagram illustrating a schematic configuration of a first processing circuit 340 in another imager.

The first processing circuit 340 is used instead of the first processing circuit 140 of the scanner 100, and performs the medium reading process and the update process instead of the first processing circuit 140. The first processing circuit 340 includes an output control circuit 341, a reception circuit 342, a control circuit 343, and a second reception circuit 344. These circuits may be implemented by independent integrated circuits, microprocessors, firmware, or a combination thereof.

The output control circuit 341 is an example of an output control unit and functions in the same or substantially the same manner as the output control unit 141. The output control circuit 341 generates display data and outputs the display data to the display and operation device 105 or the first communication device 122.

The reception circuit 342 is an example of a reception unit and functions in the same or substantially the same manner as the reception unit 142. The reception circuit 342 receives a first operation signal from the display and operation device 105 or the first communication device 122, and outputs the type or the medium state or the setting relating to each process specified in the first operation signal to the control circuit 343.

The control circuit 343 is an example of a control unit and functions in the same or substantially the same manner as the control unit 143. The control circuit 343 receives the type or the medium state or the setting relating to each process from the reception circuit 342, reads the setting table from the first memory 130, and identifies the setting relating to each process. The control circuit 343 receives a media signal from the media sensor 111 and controls the imaging device 116 and the driving source 121 according to the received media signal and the identified setting. The control circuit 343 acquires an input image from the imaging device 116 and outputs the input image to the first communication device 122.

The second reception circuit 344 is an example of a second reception unit and functions in the same or substantially the same manner as the second reception unit 144. The second reception circuit 344 receives an update signal from the display and operation device 105 or the first communication device 122, and updates the setting table stored in the first memory 130 based on the received update signal.

As described above in detail, even when the imager uses the first processing circuit 340, the imager can appropriately control the conveyor or the imaging device 116 or appropriately perform the image processing on the input image.

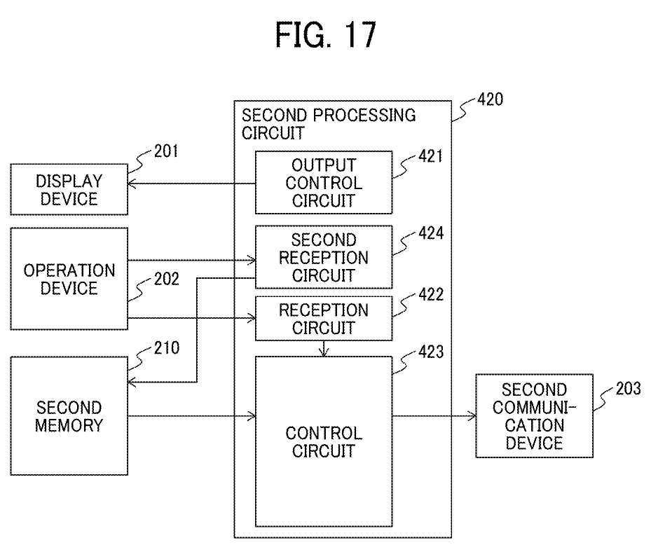

FIG. 17 is a diagram illustrating a schematic configuration of a second processing circuit 420 in another information processing apparatus.

The second processing circuit 420 is used instead of the second processing circuit 220 of the information processing apparatus 200, and performs the setting process and the reception process instead of the second processing circuit 220. The second processing circuit 420 includes an output control circuit 421, a reception circuit 422, a control circuit 423, and a second reception circuit 424. These circuits may be implemented by independent integrated circuits, microprocessors, firmware, or a combination thereof.

The output control circuit 421 is an example of an output control unit and functions in the same or substantially the same manner as the output control unit 221. The output control circuit 421 generates display data and outputs the display data to the display device 201.

The reception circuit 422 is an example of a reception unit and functions in the same or substantially the same manner as the reception unit 222. The reception circuit 422 receives a second operation signal from the operation device 202, and outputs the type or the medium state or the setting relating to each process specified in the second operation signal to the control circuit 423.

The control circuit 423 is an example of a control unit and functions in the same or substantially the same manner as the control unit 223. The control circuit 423 receives the type or the medium state or the setting relating to each process from the reception circuit 422, reads the setting table from the second memory 210, and identifies the setting relating to each process. The control circuit 423 outputs a first operation signal specifying the identified setting to the second communication device 203.

The second reception circuit 424 is an example of a second reception unit and functions in the same or substantially the same manner as the second reception unit 224. The second reception circuit 424 receives an update signal from the operation device 202, and updates the setting table stored in the second memory 210 based on the received update signal.

As described above in detail, even when the information processing apparatus uses the second processing circuit 420, the information processing apparatus can appropriately control the conveyor or the imaging device 116 of the scanner 100, or can appropriately perform the image processing on the input image.

Embodiments of the present disclosure are not limited to the above-described embodiments. For example, the medium conveying path of the scanner 100 may have a so-called U-turn path mechanism, and the scanner 100 may feed and convey media placed on the media tray sequentially from the top and eject the media to the ejection tray. In this configuration, the separation roller is located below the feed roller to face the feed roller.

Embodiments of the present disclosure are not limited to the above-described embodiments. For example, the medium conveying path of the scanner 100 may have a so-called U-turn path mechanism, and the scanner 100 may feed and convey media placed on the media tray sequentially from the top and eject the media to the ejection tray. In this configuration, the separation roller is located below the feed roller to face the feed roller.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An imager comprising:
an imaging device including an imaging sensor; and
circuitry configured to:
receive, from an information processing apparatus, an operation signal for a process corresponding to one of a type and a state of a medium having an overlapping portion, wherein the information processing apparatus is external to the imager; and
control the imaging device according to the received operation signal, to image the medium and generate an input image; and
transmit the input image to the information processing apparatus,
wherein the information processing apparatus performs a double-page spread combination process or a rearrangement process on the received input image according to the one of the type and the state of the medium.

2. The imager according to claim 1,
wherein the circuitry is further configured to output display data for displaying, in a selectable manner, the one of the type and the state of the medium having the overlapping portion.

3. The imager according to claim 1,
wherein the type includes at least one of a medium with an attachment, an envelope, a medium with a copy sheet attached, a double-page spread medium, or a booklet-shaped medium.

4. The imager according to claim 3,
wherein, when the type includes the double-page spread medium or the booklet-shaped medium, the type is either a medium including a portion continuous over multiple pages or a medium not including a portion continuous over multiple pages.

5. The imager according to claim 1,
wherein the state includes at least one of a state with an attachment, an enclosed state, a state with a copy sheet attached, a folded state with a double-page spread on an outer side, or a booklet‑folded state.

6. The imager according to claim 5,
wherein, when the state includes the folded state with the double-page spread on the outer side or the booklet-folded state, the state is either a state including a portion continuous over multiple pages or a state not including a portion continuous over multiple pages.

7. The imager according to claim 1,
wherein the operation signal includes at least one of a setting relating to the imaging device, the double-page spread combination process, or the rearrangement process.

8. The imager according to claim 1,
wherein the circuitry is configured to receive one of
a specification indicating an operation performed by the imaging device corresponding to the one of the type and the state of the medium having the overlapping portion,
a specification indicating the double-page spread combination process corresponding to the one of the type and the state of the medium having the overlapping portion, and
a specification indicating the rearrangement process corresponding to the one of the type and the state of the medium having the overlapping portion.

9. An imager comprising:
a conveyor to convey a medium;
an imaging device including an imaging sensor, to image the medium conveyed by the conveyor and generate an input image; and
circuitry configured to:
receive a specification indicating one of a type and a state of a medium having an overlapping portion; and
perform at least one of controlling the imaging device according to the one of the type and the state to process the input image, performing image processing on the input image, or controlling an external device to perform image processing on the input image, wherein the external device is external to the imager.

10. A computer-readable, non-transitory medium storing a plurality of instructions that, when executed by one or more processors of an information processing apparatus, cause the one or more processors to execute a method, the method comprising:
receiving a specification indicating one of a type and a state of a medium having an overlapping portion;
receiving an input image generated by an imager that images a medium; and
performing a double-page spread combination process or a rearrangement process on the received input image according to the one of the type and the state of the medium.
